(19) United States
(12) Patent Application Publication
(10) Pub. No.: US 2005/0201629 A1
(43) Pub. Date: Sep. 15, 2005

(54) Method and system for scalable binarization of video data

(75) Inventors: Marta Karczewicz, Irving, TX (US); Yiliang Bao, Coppell, TX (US); Justin Ridge, Sachse, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/797,467

(22) Filed: Mar. 9, 2004

(51) Int. Cl. G06K 9/36; G06K 9/46

(52) U.S. Cl. 382/240; 382/239

(57) ABSTRACT

A binarization procedure in scalable video coding, wherein a video sequence is encoded in a manner such that an encoded sequence characterized by a lower bit rate can be produced through selective removal of bits from the bitstream. The binarization procedure is used to form a plurality of enhancement layers, each of which is associated with a quantization step-size. An interval is obtained based on the quantization step-size and the reconstructed values of the enhancement layer coefficients. Based on the predicted values of the enhancement layer coefficients and the original coefficients of the video data, the interval is refined and the reconstruction values are recomputed in order to reduce the quantization step-size for the next enhancement layer.

### FIELD OF THE INVENTION

The present invention relates to the field of video coding, and more specifically to scalable video coding.

### BACKGROUND OF THE INVENTION

Conventional video coding standards (e.g. MPEG-1, H.261/263/264) involve encoding a video sequence according to a particular bit rate target. Once encoded, the standards do not provide a mechanism for transmitting or decoding the video sequence at a different bit rate setting to the one used for encoding. Consequently, when a lower bit rate version is required, computational effort must be devoted to (at least partially) decoding and re-encoding the video sequence.

Existing scalable video coding algorithms generally use one of two approaches to achieve bit-rate scalability:
1. Bit-plane coding, where the Nth bit plane is formed by taking the Nth binary digit from the binary representation of each value to be encoded, as shown in FIG. 1. Each bit plane forms a “layer”. A lower bit-rate (and consequently lower quality) representation of the original values may be formed by omitting the higher layers.
2. The value may be quantized to give a “base layer” representation. Then an “enhancement layer” is formed by quantizing the original value using a finer quantizer, and encoding the difference between that quantized representation and the base layer representation. Additional enhancement layers are generated by using successively finer quantization.

The first technique may be viewed as a specific case of the second, where the quantizer step size is halved for each enhancement layer.

The majority of prediction error values (or “residuals”) have a small magnitude—often zero or one; consequently in the case of bit plane coding, the first bit plane tends to contain a large amount of information. Furthermore, when a magnitude changes from zero to one (due to finer quantization in an enhancement layer), sign information must also be encoded. For these reasons, the bit-rate “step” from the base layer to the first enhancement layer is often unacceptably large with bit plane coding. For example, if a base layer is encoded at 128 Kbps, the first enhancement layer may increase the rate to 256 Kbps; an intermediate bit-rate may not be achievable.

To overcome the limit bit plane coding imposes on the “granularity” of scalability, the second approach described above is sometimes used, where the quantizer step size decreases in a non-exponential fashion (e.g. quantization progresses from divide-by-two to divide-by-three between the first two layers, instead of progressing from divide-by-two to divide-by-four). Because a more gradual decrease in the quantizer step size is used, it is possible to achieve intermediate bit-rates. Such coders are also able to use a different “reference frame” for each layer in computing the prediction error. However, when the decrease in step size is not exponential, the binary values in one layer are not independent of their counterparts in the previous layer; i.e. to some extent, information from the previous layer is being “re-encoded”. Hence such a scheme sacrifices coding efficiency for “granularity” of scalability.

It is thus advantageous and desirable to provide a method and device for video coding, wherein data is encoded in a manner such that the feature of scalability is achieved without detriment to the overall coding efficiency.

### SUMMARY OF THE INVENTION

The present invention is mainly concerned with scalable video coding, wherein a video sequence is encoded in a manner such that an encoded sequence characterized by a lower bit rate can be produced through selective removal of bits from the bitstream.

Scalable video coding can be achieved either through removal of entire coefficient values (or pixel values, depending upon the specific coder implementation) while leaving others intact; or by converting the coefficient values into a binary representation in such a manner that selectively removing bits from the binary representation preserves the integrity of the remaining bits, i.e. the remaining data may still be decoded. The present invention focuses on the process of converting the coefficient values into a binary representation by selective bit removal, in a process referred herein as “binarization”.

Thus, the first aspect of the present invention provides a method in scalable media data coding, wherein original media data having a plurality of original coefficients is presented in a plurality of layers including a base layer, the base layer associated with a plurality of base-layer coefficients corresponding to original coefficients, each original coefficient having an original value, and wherein a binarization procedure is undertaken for forming a plurality of enhancement layers, each enhancement layer having a plurality of enhancement layer coefficients corresponding to the base-layer coefficients and at least partially based upon a predicted value of the enhancement layer coefficients corresponding to the original coefficients. The method comprises the steps of:

obtaining intervals at least partially based on a quantization step-size of an enhancement layer and reconstructed values of the enhancement layer coefficients associated with at least one of a plurality of layers including said enhancement layer, other enhancement layer and the base layer;

refining the intervals at least partially based on the relationship between the predicted values, the original coefficients and the intervals;

re-computing the reconstructed values; and

reducing the quantization step-size for a next coefficient and a next enhancement layer.

According to the present invention, the obtaining step comprises:

computing one of said intervals for each original coefficient to be encoded based on a reconstructed value corresponding to said each original coefficient and the quantization step-size.

According to the present invention, the method further comprises the step of:

possibly emitting a binary digit value (0 or 1) at least partially depending upon the position of said each original coefficient, the position of the predicted value of the enhancement layer coefficient corresponding to said each original coefficient, relative to each other and relative to said interval, for refining said interval at least partially based on the emitted value for providing a refined interval.

According to the present invention, the step for re-computing the reconstructed value is at least partially based on said refined interval.

According to the present invention, the method further comprises the step of:

repeating said obtaining, emitting, refining, re-computing and reducing until the quantization step-size reaches a predetermined value, which can be zero.

According to the present invention, the interval has a center, and the emitted value is one or zero is partially depending upon the position of said each original coefficient relative to the center of the interval.

According to the present invention, the nterval has a boundary and the step of refining the interval is at least partially based upon whether said each original coefficient falls within the boundary of the interval.

The second aspect of the present invention provides a coding device for use in scalable media data coding, wherein original media data having a plurality of original coefficients is presented in a plurality of layers including a base layer, the base layer associated with a plurality of base-layer coefficients corresponding to original coefficients, each original coefficient having an original value, and wherein a binarization procedure is undertaken for forming a plurality of enhancement layers, each enhancement layer having a plurality of enhancement layer coefficients corresponding to the base-layer coefficients and at least partially based upon a predicted value of the enhancement layer coefficients corresponding to the original coefficients. The device comprises:

a binarization module, responsive to the original media data, for providing a signal indicative to binarized data; and

a coding module, responsive to the signal, for providing encoded media data at least partially based on the binarized data, wherein the binarization module comprises a mechanism to carry out the steps of:

obtaining intervals at least partially based on a quantization step-size of an enhancement layer and reconstructed values of the enhancement layer coefficients associated with at least one of a plurality of layers including said enhancement layer, other enhancement layers and the base layer;

refining the intervals at least partially based on the relationship between the predicted values, the original coefficients and the intervals;

re-computing the reconstructed values; and

reducing the quantization step-size for a next coefficient and a next enhancement layer.

According to the present invention, the obtaining step comprises:

computing one of said intervals for each original coefficient to be encoded based on a reconstructed value corresponding to said each original coefficient and the quantization step-size.

According to the present invention, the mechanism further carries the step of:

possibly emitting a value for providing the binarized data at least partially depending upon the position of said each original coefficient, the position of the predicted value of the enhancement layer coefficient corresponding to said each original coefficient, relative to each other and relative to said interval, for refining said interval at least partially based on the emitted value for providing a refined interval.

According to the present invention, the step of re-computing the reconstructed value is at least partially based on said refined interval.

According to the present invention, the mechanism further repeats the steps of obtaining, emitting, refining, re-computing and reducing until the quantization step-size reaches a predetermined value, and the mechanism comprises a software program for carrying out the steps.

According to the present invention, the device further comprises:

a base layer encoder, responsive to the original media data, for providing base layer encoded data to the coding module.

The third aspect of the present invention provides a software product for use in a scalable media data coding device, wherein original media data having a plurality of original coefficients is presented in a plurality of layers including a base layer, the base layer associated with a plurality of base-layer coefficients corresponding to original coefficients, each original coefficient having an original value, and wherein a binarization procedure is undertaken for forming a plurality of enhancement layers, each enhancement layer having a plurality of enhancement layer coefficients corresponding to the base-layer coefficients and at least partially based upon a predicted value of the enhancement layer coefficients corresponding to the original coefficients. The software product comprises:

a code for obtaining intervals at least partially based on a quantization step-size of an enhancement layer and reconstructed values of the enhancement layer coefficients associated with at least one of a plurality of layers including said enhancement layer, other enhancement layers and the base layer;

a code for refining the intervals at least partially based on the relationship between the predicted values, the original coefficients and the intervals;

a code for re-computing the reconstructed values; and

a code for reducing the quantization step-size for a next coefficient and next enhancement layer.

According to the present invention, the code for obtaining comprises:

a code for computing one of said intervals for each original coefficient to be encoded based on a reconstructed value corresponding to said each original coefficient and the quantization step-size.

According to the present invention, the software product further comprises:

a code for possibly emitting a value at least partially depending upon the position of said each original coefficient, the position of the predicted value of the enhancement layer coefficient corresponding to said each original coefficient, relative to each other and relative to said interval, for refining said interval at least partially based on the emitted value for providing a refined interval.

According to the present invention, the code for re-computing the reconstructed value is at least partially based on said refined interval.

According to the present invention, the software program further comprises:

a processing loop for repeating the process carried out by the codes for obtaining, emitting, refining, re-computing and reducing until the quantization step-size reaches a predetermined value.

The present invention will become apparent upon reading the description taken in conjunction with FIGS. 2 to 5.

### BRIEF DESCRIPTION OF THE DRAWINGS

FIG. 1 is a schematic representation illustrating a prior art scalable video coding method.

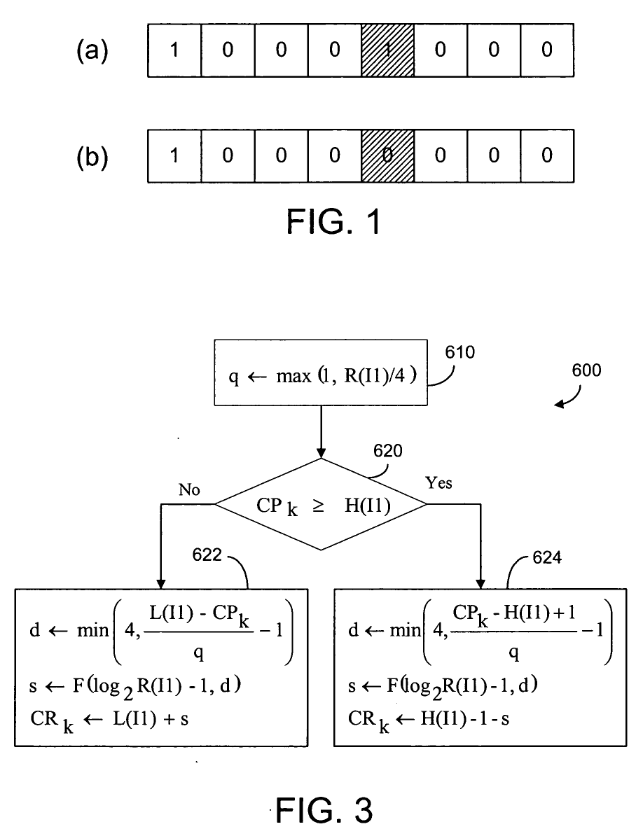

FIG. 2 is a flowchart illustrating one implementation of the scalable video coding method, according to the present invention.

FIG. 3 is a flowchart illustrating the computation of reconstructed value.

FIG. 4 is a block diagram illustrating an encoder, according to the present invention.

FIG. 5 is a block diagram illustrating a decoder, according to the present invention.

### DETAILED DESCRIPTION OF THE INVENTION

Assuming a constant resolution and frame rate, a scalable video coder achieves bit-rate scalability (sometimes equivalently called “quality scalability” or “SNR scalability”) by encoding video data in such a way that individual elements may be removed, either in part or in whole, from the encoded bit stream, while ensuring that the resulting bit stream may still be decoded at an albeit lower quality.

The “video data” to be encoded are generally transform coefficients, depending upon the precise nature of the video coder. However, the present invention can be used to encode pixel values virtually without requiring any change in the video coder.

It should be noted that, the present invention is mainly concerned with those video coding cases where coefficients are “binarized” and bit-rate scalability is achieved through removing individual bits from the binary representation of each coefficient such that the overall bit-rate of the encoded sequence decreases. Thus, the primary goal of the present invention is not to improve those video coding cases where the entire coefficients are discarded or those cases where the entire coefficients remain intact during the coding process.

The present invention provides a new way to binarize transform coefficients. The coefficient is first encoded to some “base layer” quality, so that the reconstructed value is guaranteed to be within a certain range of the original, or equivalently, the original is within a certain range of the reconstructed value. This range is herein referred to as an “interval” and the range center is based on the reconstructed value.

In subsequent “enhancement layers”, a predicted value of the coefficient is formulated and serves as one input to the binarization process, along with the reconstructed value from the previous (i.e. next-lower) layer. However, how the prediction is exactly determined is not part of the present invention.

An important feature of the present invention is that, if both the predicted value of the coefficient and the original are known to lie within the same interval, then both the predicted value of the coefficient and the reconstructed value from the previous layer are utilized in determining what binary symbols will be encoded. In particular, the relative positions of the predicted and original coefficient values to the interval center and/or interval boundaries are used to determine the binary symbols used to represent the coefficient.

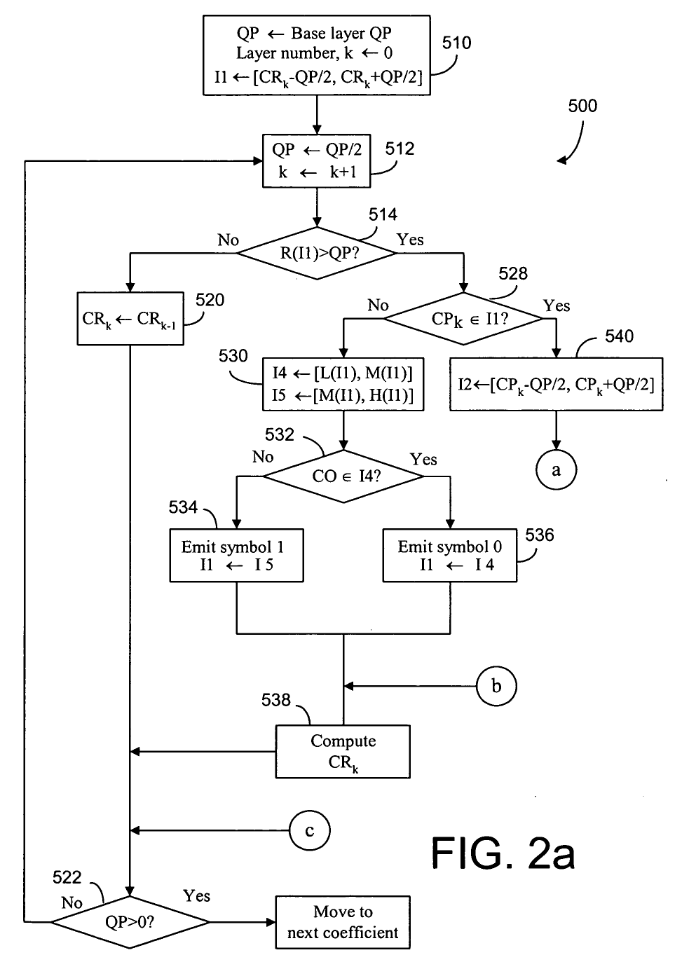

An implementation of the binarization method, according to the present invention, is illustrated in a flowchart as shown in FIGS. 2a and 2b. As shown in the flowchart 500, the first step 510 of the binarization procedure starts with setting the quantizer step size, or “quantization parameter” (QP) based on the QP of a certain base layer. For the first enhancement layer, or k=0, the reconstructed value CR₀ of a coefficient from the base layer is placed in the center of the QP-sized interval I1, such that I1=[CR₀−QP/2, CR₀+QP/2]. At step 512, the quantizer step size QP is reduced by half and the layer index k is increased by 1. A check is performed at step 514 to make sure that the range, R, of the interval I1 is always valid during the entire binarization process. If the range R(I1) at any stage remains valid, then the procedure proceeds to step 528. Otherwise the reconstructed coefficient from the previous layer becomes the reconstructed value for the current layer, as shown at step 520. The process goes on until QP equal to a predetermined value or 0, as shown at step 522. At step 528, a check is performed to determine whether the enhancement layer prediction of the coefficient CPₖ (k=1 in the first loop) is within the initial interval I1. It should be noted that, the predicted value, CPₖ, of a coefficient at layer k, can be obtained by various techniques. For example, the technique of motion compensation may be applied to yield the predicted values. The exact method of computing CPₖ is not part of the present invention.

(A) If CP₁ does lie within I1, a second interval is formed at step 540 based on the predicted value, I2=[CP_{k-QP/}2, CPₖ+QP/2], and a third interval is then formed (in branch a in the flowchart) as shown in FIG. 2b.

I3, along with I4 and I5, are formed in three different ways depending on the size of I2 in relation to I1, as determined at steps 542 and 550. Here L(Ix) denotes the lower bound of interval Ix; H(Ix) denotes the upper bound of interval Ix; R(Ix) is the range of interval Ix, given by [H(Ix)−L(Ix)]; and M(Ix) is the midpoint of interval Ix, given by [H(Ix)+L(Ix)]/2.
1. If I2 is entirely contained within I1, then I3 is set to equal I2 at step 544. At the same step, I4 and I5 are also set.
2. If I2 straddles the lower bound of I1, then I3 and I4 are set to the lower half of the interval I1 at step 552. At the same step, I5 is set to the upper half of the interval I1.
3. If I2 straddles the upper bound of I1, then I3 and I5 are set to the upper half of interval I1, and I4 is set to the lower half of interval I1I1 is split in half at step 554.

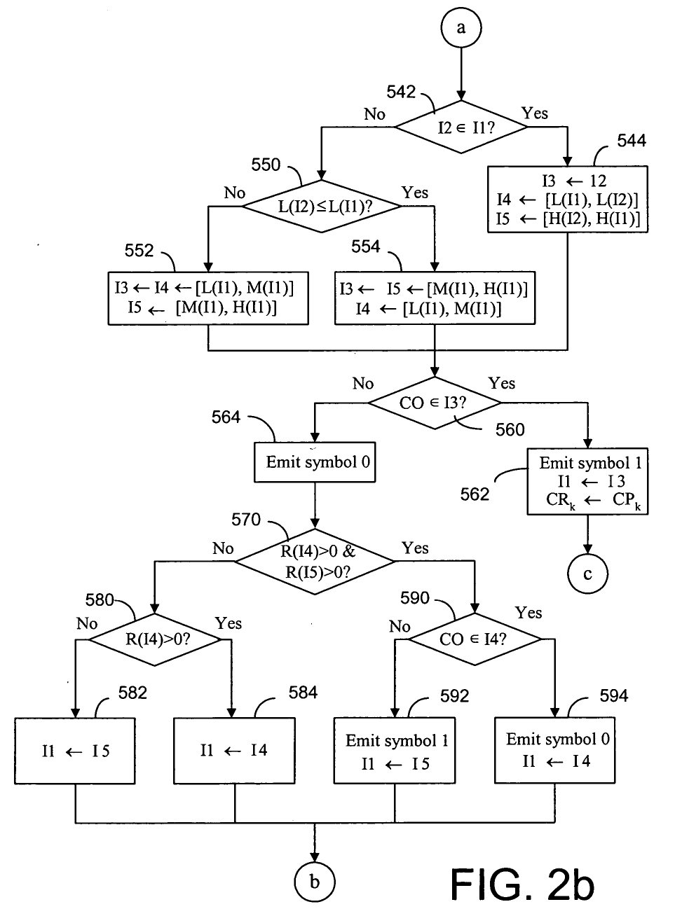

After the intervals I3, I4 and I5 are set (effectively splitting I1 in half—see steps 562, 582, 584, 592, 594), a check is performed at step 560 to determine whether the original coefficient values (CO) lies within interval I3 as follows:
1. If CO does lie within interval I3, a binary “one” is encoded at step 562. At the same step, interval I1 is reset to the value of I3 (splitting I1 in half), and the reconstructed value of coefficient at layer k is set to the corresponding predicted value. If QP is not equal to zero, then the next coefficient is encoded in a similar fashion.
2. Otherwise a binary “zero” is encoded at step 564. It is followed that the interval I1 is halved by setting I1 either to I4 or I5.
   If it is determined at step 570 that neither half is zero length, a binary symbol “one” or “zero” is encoded (at step 592 or step 594) to indicate which half contains CO (step 590). I1 is reset to the corresponding half at step 592 or 594.
   If, after partitioning I1, one half does have zero length as determined at step 570, interval I1 is reset to the non-zero segment, according to steps 580, 582 and 584.
   After the interval I1 is reset, the reconstructed value of coefficient at layer k is computed at step 538 in accordance with the method as shown in flowchart 600 (FIG. 3).

(B) If CP1 does not lie within I1 as determined at step 528, the interval is halved into a “lower interval” I4, and an “upper interval” I5 at step 530. The interval containing the original coefficient value (CO) is selected as step 532, and a binary digit is encoded at step 534 or 536 to indicate which of the two intervals is selected and I1 is also halved accordingly.

In cases where the reconstructed coefficient, CRₖ, is not simply copied from the predicted value, CPₖ (step 562) or the previous-layer reconstructed value CRₖ₋₁ (step 520), a process for determining the reconstructed value is given by the flowchart 600, as shown in FIG. 3. Here, the range of interval I1 is quantized (step 610), and the reconstructed value is computed by determining which half of I1 contains the predicted value (step 620) and then selecting an offset ‘s’ from the interval boundary (steps 622 and 624). The function F represents a process for computing 's' based upon the interval range and distance, d, of the predicted value from the interval boundary. The function F(x,y) is a mapping function largely influenced by the distance of the predicted value from the nearest boundary of interval I1. However, F may take the form of a mathematical function or a lookup table.

It should be noted that, the method of computing the reconstructed coefficient CRₖ as shown in FIG. 3 is only one of many possible ways of computing the reconstructed value, which could be developed utilizing the principle that the offset of the reconstructed value from the interval boundary is related to the distance of the predicted value from the interval boundary.

As illustrated in the flowchart 500, the present invention uses the position of the predicted value within the interval as part of the step of determining a reconstructed value for the current enhancement layer. In the statistically less probable event that the prediction does not lie within the interval, a more conventional binarization approach is used where the interval is halved and a binary digit used to indicate which half contains the original coefficient value.

The present invention guarantees that a coefficient will be monotonically refined towards the original value, i.e. the distance between the reconstructed and original values will not increase from one refinement layer to the next. Following the binarization process, the binary symbols may be encoded using context-based arithmetic coding. In the present invention, the contexts for arithmetic coding are formulated in a novel way. The inputs to the context selector are:
whether the predicted and reconstructed values in the previous layer were identical or not;
the processing block where the binary digit bit is emitted (steps 534, 536, 564, for example); and
in the case of encoding coefficients (such as DCT coefficients), the position of the coefficient within the block of coefficients.

A simple context map involves taking all possible permutations of these input variables. A simple extension to this concept would involve merging certain permutations to form a reduced set of contexts.

Techniques such as “bit flipping”, where bits are inverted in a deterministic manner to help ensure a non-uniform probability distribution, are also possible. Such techniques are commonly known in the art.

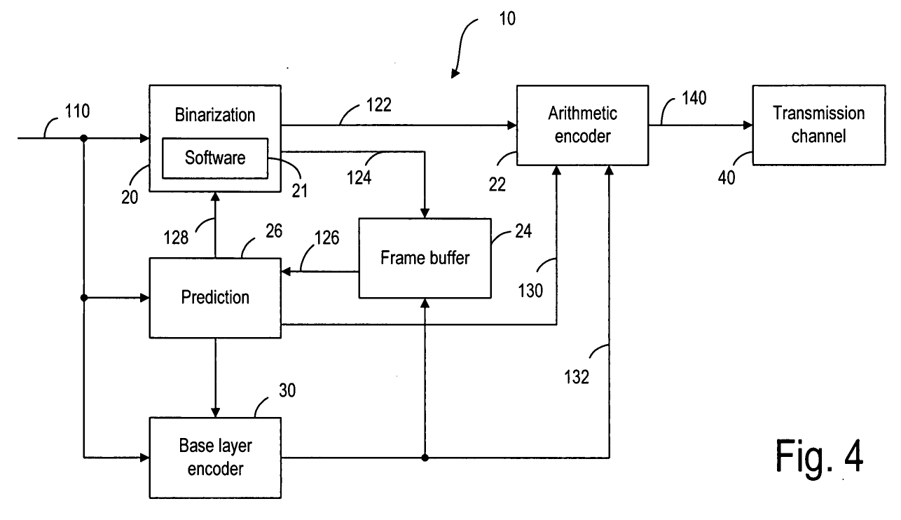

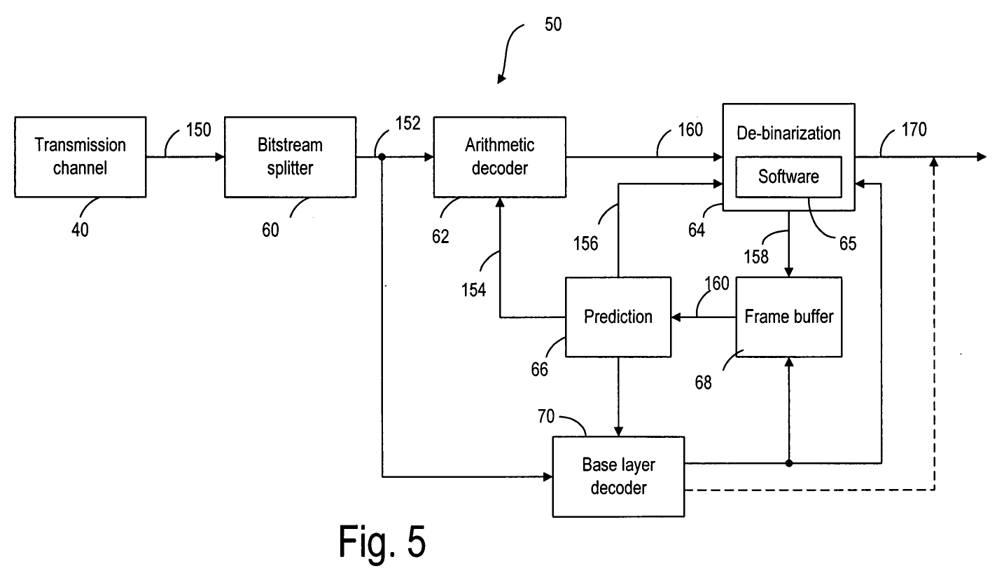

The method of coefficient binarization, according to the present invention, can be incorporated into a video coding system, as shown in FIGS. 4 and 5. FIG. 4 illustrates a video encoder 10 that uses a coefficient binarization process. As shown, the video encoder 10 comprises a binarization block 20 to emit binary bits to an arithmetic coding block 22. The binarization block 20 receives original signals 110 indicative of the original value of the coefficient (CO) and provides signals 124 indicative of the reconstructed value of the coefficient at layer k (CRₖ) to a frame buffer block 24. The frame buffer block 24 provides signals 126 indicative of the reconstructed value of the coefficient at a previous layer (k-1) (see step 520 in FIG. 2a) to the prediction block 26. Based on the original signals and the signals 126 from the frame buffer block 24, the prediction block 26 provides motion information 130 to the arithmetic coding block 22. The prediction block 26 also provides signals 128 indicative of predicted value CPₖ to the binarization block 20, allowing the binarization block to determine whether the predicted value of the enhancement layer lies within the quantizer step size (see step 528, FIG. 2a) and to compute the reconstructed value CPₖ (FIG. 3). Based on the signals 122 indicative of the emitted binary bits provided by the binarization block 20 and the motion information from the prediction block 26, the arithmetic coding block 22 submits encoded video data in a bitstream 140 to a transmission channel 40. It is understood that the binarization procedure can be carried out by hardware or software in the binarization block 20. For example, the binarization block 20 may contain a software program 21 for compare the predicted value with the quantizer step size, for determining whether to emit a binary bit, for computing the reconstructed value CPₖ and for carrying out other decision steps.

Furthermore, the video encoder 10 may comprise a base layer encoder 30, operatively connected to the prediction block 26, the frame buffer block 24 and the arithmetic coding block 22, to carry out base layer encoding providing a signal 132 indicative of base layer encoded data. The base layer encoder 30 as such is known in the art.

On the receive side, a video decoder 50 receives a bitstream 150 from the transmission channel 40 for video decoding. As shown in FIG. 5, the decoder 50 comprises a bitstream splitter 60, which is capable of removing bits from the bitstream 150 so as to reduce the bitrate. The processed bitstream 152 is provided to an arithmetic decoder 62, along with prediction information 154 from a prediction block 66. The arithmetic decoder 62 then provides signals 160 indicative of decoded video data to a de-binarization block 64 for video reconstruction. The de-binarization block 64 is operatively connected to the prediction block 66 to receive signals 156 indicative of predicted value CPₖ. The de-binarization block 64 provides signals 158 indicative of the reconstructed value CRₖ to a frame buffer block 68, which provides signals 160 indicative of the reconstructed value CRₖ₋₁ to the prediction block 66. The de-binarization block 64 provides reconstructed video signals 170 to a media player or the like (not shown). It is understood that the de-binarization block 64 may comprise a software program 65 to carry out the functions of the de-binarization block.

Furthermore, the video decoder 50 may comprise a base layer decoder 70, operatively connected to the prediction block 66, the frame buffer 68 and the de-binarization block 64 to carry out base layer decoding based on the video data from the bitstream 150. It is possible to view the decoded video signals (the dashed line) directly from the base layer decoder 70 without decoding the enhancement layers. Base layer decoder 70 is known in the art.

It should be noted that the interval as previously described is divided by two, but the division is not necessary of equal length. The intervals can be formed after considering the positions of the original coefficient and the predicted value. Furthermore, where bits emitted from the binarization module are provided to a context-based arithmetic encoder. The arithmetic encoding can be based on one of more of the following: (1) whether the predicted and reconstructed values in the previous layer are identical; (2) the stage of binarization process that causes the bit to be emitted and (3) the position of the value being coded within a block of values.

In sum, the method of coefficient binarization, according to present invention, is characterized by
maintaining an interval in which the original coefficient is known to lie; and
classifying the prediction for a given layer as “accurate” or “inaccurate” by considering whether or not the predicted value falls within a maintained interval.
for predictions classified as “accurate”, further classification is performed depending the position of both the predicted and original coefficient values within the interval, specifically whether both the predicted and original coefficient values lie within the same sub-section of the maintained interval.

By repeating the maintaining and classifying steps, prediction for each enhancement layer can be categorized as belonging to one of two or more “degrees” of accuracy.

Thus, the method is characterized by:
generating binary symbols for the enhancement layer, where such symbols depend upon the classification of the prediction, i.e. as “highly accurate”, “accurate”, or “inaccurate”;
updating the maintained interval by selecting a sub-interval from it, where the center and size of the sub-interval depends upon the classification of the prediction. In particular, the sub-interval is not limited to being half the size of the current maintained interval;
updating the maintained interval by selecting a sub-interval from it, where that sub-interval depends not only upon the classification of the prediction as stated above, but also upon the position of the predicted value and original coefficient value relative to the maintained interval.
determining the reconstructed coefficient value for the current layer based upon the prediction classification. In particular:
   1. using the predicted value as the reconstructed value if the prediction classification is above some threshold, e.g. “highly accurate”; and
   2. using a mathematical formula to compute the reconstructed coefficient value, where said formula incorporates the prediction value, but where the extent to which the prediction is considered is influenced by the prediction classification and/or the distance of the predicted value from the maintained interval in which the original value is known to lie.

Unlike the “simple” binarization process which halves an interval and sends a one or a zero depending on which half contains the value to be encoded, the present invention considers division of an interval into an arbitrary and not necessarily equally-sized number of sub-intervals.

Additionally, the present invention permits the predicted value to differ from one layer to the next. Furthermore, the present invention places no constraint on the monotonicity of the prediction, i.e. it need not become progressively closer to the original in higher enhancement layers.

The concepts and principles of scalable video coding, according to the present invention, can be extended to any application where a digital signal needs to be refined toward an original (or “ideal”) value and a prediction of the original is available at the refinement points. Hence, the present invention is applicable to still-image, speech, or audio data as well as video data.

Although the invention has been described with respect to one or more embodiments thereof, it will be understood by those skilled in the art that the foregoing and various other changes, omissions and deviations in the form and detail thereof may be made without departing from the scope of this invention.

1. A method in scalable media data coding, wherein original media data having a plurality of original coefficients is presented in a plurality of layers including a base layer, the base layer associated with a plurality of base-layer coefficients corresponding to original coefficients, each original coefficient having an original value, and wherein a binarization procedure is undertaken for forming a plurality of enhancement layers, each enhancement layer having a plurality of enhancement layer coefficients corresponding to the base-layer coefficients and at least partially based upon a predicted value of the enhancement layer coefficients corresponding to the original coefficients, said method comprising:
obtaining intervals at least partially based on a quantization step-size of an enhancement layer and reconstructed values of the enhancement layer coefficients associated with at least one of a plurality of layers including said enhancement layer, other enhancement layers and the base layer;
refining the intervals at least partially based on the relationship between the predicted values, the original coefficients and the intervals;
re-computing the reconstructed values; and
reducing the quantization step-size for a next coefficient and a next enhancement layer.

2. The method of claim 1, wherein said obtaining comprises:
computing one of said intervals for each original coefficient to be encoded based on a reconstructed value corresponding to said each original coefficient and the quantization step-size.

3. The method of claim 2, further comprising:
possibly emitting a value at least partially depending upon the position of said each original coefficient, the position of the predicted value of the enhancement layer coefficient corresponding to said each original coefficient, relative to each other and relative to said interval, for refining said interval at least partially based on the emitted value for providing a refined interval.

4. The method of claim 3, wherein said re-computing of the reconstructed value is at least partially based on said refined interval.

5. The method of claim 4, further comprising:
repeating said obtaining, emitting, refining, re-computing and reducing until the quantization step-size reaches a predetermined value.

6. The method of claim 5, wherein the predetermined value is zero.

7. The method of claim 3, wherein the value is a binary digit value.

8. The method of claim 7, wherein the value is one of two binary digit values of zero and one.

9. The method of claim 8, wherein said interval has a center, and wherein the emitted value is one or zero is partially depending upon the position of said each original coefficient relative to the center of the interval.

10. The method of claim 2, wherein said interval has a boundary and wherein said refining of the interval is at least partially based upon whether said each original coefficient falls within the boundary of the interval.

11. A coding device for use in scalable media data coding, wherein original media data having a plurality of original coefficients is presented in a plurality of layers including a base layer, the base layer associated with a plurality of base-layer coefficients corresponding to original coefficients, each original coefficient having an original value, and wherein a binarization procedure is undertaken for forming a plurality of enhancement layers, each enhancement layer having a plurality of enhancement layer coefficients corresponding to the base-layer coefficients and at least partially based upon a predicted value of the enhancement layer coefficients corresponding to the original coefficients, said device comprising:
a binarization module, responsive to the original media data, for providing a signal indicative to binarized data; and
a coding module, responsive to the signal, for providing encoded media data at least partially based on the binarized data, wherein the binarization module comprises a mechanism to carry out the steps of:
obtaining intervals at least partially based on a quantization step-size of an enhancement layer and reconstructed values of the enhancement layer coefficients associated with at least one of a plurality of layers including said enhancement layer, other enhancement layers and the base layer;
refining the intervals at least partially based on the relationship between the predicted values, the original coefficients and the intervals;
re-computing the reconstructed values; and
reducing the quantization step-size for a next coefficient and a next enhancement layer.

12. The device of claim 11, wherein the obtaining step comprises:
computing one of said intervals for each original coefficient to be encoded based on a reconstructed value corresponding to said each original coefficient and the quantization step-size.

13. The device of claim 12, wherein the mechanism further carries out the step of:
possibly emitting a value for providing the binarized data at least partially depending upon the position of said each original coefficient, the position of the predicted value of the enhancement layer coefficient corresponding to said each original coefficient, relative to each other and relative to said interval, for refining said interval at least partially based on the emitted value for providing a refined interval.

14. The device of claim 13, wherein the step of re-computing the reconstructed value is at least partially based on said refined interval.

15. The device of claim 14, wherein the mechanism further repeats the steps of obtaining, emitting, refining, re-computing and reducing until the quantization step-size reaches a predetermined value.

16. The device of claim 13, wherein the binarized data contains binary digit values of zero and one.

17. The device of claim 11, further comprising:
a base layer encoder, responsive to the original media data, for providing base layer encoded data to the coding module.

18. The device of claim 11, wherein the mechanism comprises a software program for carrying out the steps.

19. A software product for use in a scalable media data coding device, wherein original media data having a plurality of original coefficients is presented in a plurality of layers including a base layer, the base layer associated with a plurality of base-layer coefficients corresponding to original coefficients, each original coefficient having an original value, and wherein a binarization procedure is undertaken for forming a plurality of enhancement layers, each enhancement layer having a plurality of enhancement layer coefficients corresponding to the base-layer coefficients and at least partially based upon a predicted value of the enhancement layer coefficients corresponding to the original coefficients, said software product comprising:
a code for obtaining intervals at least partially based on a quantization step-size of an enhancement layer and reconstructed values of the enhancement layer coefficients associated with at least one of a plurality of layers including said enhancement layer, other enhancement layers and the base layer;
a code for refining the intervals at least partially based on the relationship between the predicted values, the original coefficients and the intervals;
a code for re-computing the reconstructed values; and
a code for reducing the quantization step-size for a next coefficient and a next enhancement layer.

20. The software product of claim 19, wherein the code for obtaining comprises:
a code for computing one of said intervals for each original coefficient to be encoded based on a reconstructed value corresponding to said each original coefficient and the quantization step-size.

21. The software product of claim 20, further comprising:
a code for possibly emitting a value at least partially dependent upon the position of said each original coefficient, the position of the predicted value of the enhancement layer coefficient corresponding to said each original coefficient, relative to each other and relative to said interval, for refining said interval at least partially based on the emitted value for providing a refined interval.

22. The software produce of claim 21, wherein the code for re-computing the reconstructed value is at least partially based on said refined interval.

23. The software product of claim 22, further comprising:
a processing loop for repeating the codes for obtaining, emitting, refining, re-computing and reducing until the quantization step-size reaches a predetermined value.
